(19) United States
(12) Patent Application Publication
(10) Pub. No.: US 2004/0027321 A1
(43) Pub. Date: Feb. 12, 2004

(54) Switched amplifier drive circuit for liquid crystal displays

(76) Inventor: Eugene Murphy O'Donnell, Fishers, IN (US)

Correspondence Address: Joseph S Tripoli, Thomson Multimedia Licensing Inc, P O Box 5312, Princeton, NJ, 08540, US

(21) Appl. No.: 10/433,163

(22) PCT Filed: Nov. 29, 2001
(86) PCT No.: PCT/US01/44896

(51) Int. Cl. G09G 3/36

(52) U.S. Cl. 345/87

(57) ABSTRACT

A cell driver (70) for a display unit (50) having a memory element and a liquid crystal cell among a plurality of liquid crystal cells includes a first storage capacitor (14) and a first differential amplifier (16) selectively coupled between the first storage capacitor and the liquid crystal cell forming a first drive circuit. The cell driver also includes a second storage capacitor (14′) and a second differential amplifier (16′) coupled between the second storage capacitor and the liquid crystal cell forming a second drive circuit A switching mechanism (72 and 74) is used for switching the liquid crystal cell between the first and second drive circuits.

### BACKGROUND OF THE INVENTION

1. Field of the Invention

This invention relates to the field of video systems utilizing a liquid crystal display (LCD) or liquid crystal on silicon (LCOS), and in particular, to a switched driver circuit for such displays.

2. Description of Related Art

Liquid crystal on silicon (LCOS) can be thought of as one large liquid crystal formed on a silicon wafer. The silicon wafer is divided into an incremental array of tiny plate electrodes. A tiny incremental region of the liquid crystal is influenced by the electric field generated by each tiny plate and the common plate. Each such tiny plate and corresponding liquid crystal region are together referred to as a cell of the imager. Each cell corresponds to an individually controllable pixel. A common plate electrode is disposed on the other side of the liquid crystal (LC). The drive voltages are supplied to plate electrodes on each side of the LCOS array. Each cell, or pixel, remains lighted with the same intensity until the input signal is changed, thus acting as a sample and hold. Each set of common and variable plate electrodes forms an imager. One imager is provided for each color, in this case, one imager each for red, green and blue.

It is typical to drive the imager of an LCOS display with a frame-doubled signal to avoid 30 Hz flicker, by sending first a normal frame in which the voltage at the electrodes associated with each cell is positive with respect to the voltage at the common electrode (positive picture) and then an inverted frame in which the voltage at the electrodes associated with each cell is negative with respect the voltage at the common electrode (negative picture) in response to a given input picture. The generation of positive and negative pictures ensures that each pixel will be written with a positive electric field followed by a negative electric field. The resulting drive field has a zero DC component, which is necessary to avoid the image sticking, and ultimately, permanent degradation of the imager. It has been determined that the human eye responds to the average value of the brightness of the pixels produced by these positive and negative pictures.

The present state of the art in LCOS requires the adjustment of the common-mode electrode voltage, denoted VITO, to be precisely between the positive and negative field drive for the LCOS. The subscript ITO refers to the material indium tin oxide. The average balance is necessary in order to minimize flicker, as well as to prevent a phenomenon known as image sticking.

In the current art, the LCOS drive cell looks much like a conventional Active Matrix LCD driver. This does not work well, due to the various artifacts discussed in the literature. The main causes are parasitic capacitance cross-talk, residual voltage in the LC cell, and voltage droop of the LC, due to ionic leakage and bulk resistivity of the LC material. Mainly this has been solved by: 1. Increasing the cell capacitance (limited by physical area), 2. Changing to higher resistivity LC materials (limits flexibility and response time), 3. Increasing the frame scan rate to more than 60Hz (expensive, and costs more bandwidth). 4. Strongly controlling the temperature of the device, to maintain high voltage holding ratio (VHR).

The main cause for all of the above issues is that the available charge is only transferred to the LC cell once per frame. In a display with a million pixels, this limits the available power and doesn't allow for any closed-loop check that the desired voltage has actually been achieved on the pixel electrode. Additionally, the issues of flicker, drive voltage, and image retention have been addressed in various ways for digital drive LCOS displays, but such methods fail to provide a solution to the problem in analog systems due to the need for continuous updating. Thus, a need exists for a display driver that provides adequate isolation between a storage capacitor and a liquid crystal cell and further eliminates flicker without the need for frame doubling.

### BRIEF SUMMARY OF THE INVENTION

In a first aspect of the present invention, a display driver for a display unit having a memory and a liquid crystal cell among a plurality of liquid crystal displays comprises a first drive circuit coupled to a first memory element of the liquid crystal cell, a second drive circuit coupled to a second memory element of the liquid crystal cell, and a switching arrangement for switching the liquid crystal cell between the first and the second drive circuits.

In a second aspect of the present invention, a display driver among an array of array drivers for a display unit having a corresponding array of liquid crystal cells comprises a first storage capacitance and a first amplifier selectively coupled between the first storage capacitance and the liquid crystal cell forming a first drive circuit, a second storage capacitance and a second amplifier coupled between the second storage capacitance and the liquid crystal cell forming a second drive circuit, and a switching arrangement for switching the first and second drive circuits.

In a third aspect of the present invention, a method of driving a LCD/LCOS display comprises the steps of isolating a storage capacitance from a liquid crystal cell using a differential amplifier in each drive cell among a plurality of drive cells and switching among the plurality of drive cells to drive the liquid crystal cell.

### BRIEF DESCRIPTION OF THE DRAWINGS

FIG. 1 is a block diagram of a liquid crystal cell driver in accordance with the present invention.

FIG. 2 is a block diagram of another liquid crystal cell driver in accordance with the present invention.

FIG. 3 is a block diagram of a display unit utilizing a switching liquid crystal cell driver in accordance with the present invention.

FIG. 4 is a block diagram of a display unit utilizing a liquid crystal cell driver in accordance with the present invention.

FIG. 5 is a flow chart illustrating a method of driving a display in accordance with the present invention.

FIG. 6 is a timing diagram for static Vito in accordance with the present invention.

FIG. 7 is a timing diagram for a switched Vito in accordance with the present invention.

### DETAILED DESCRIPTION OF THE PREFERRED EMBODIMENTS

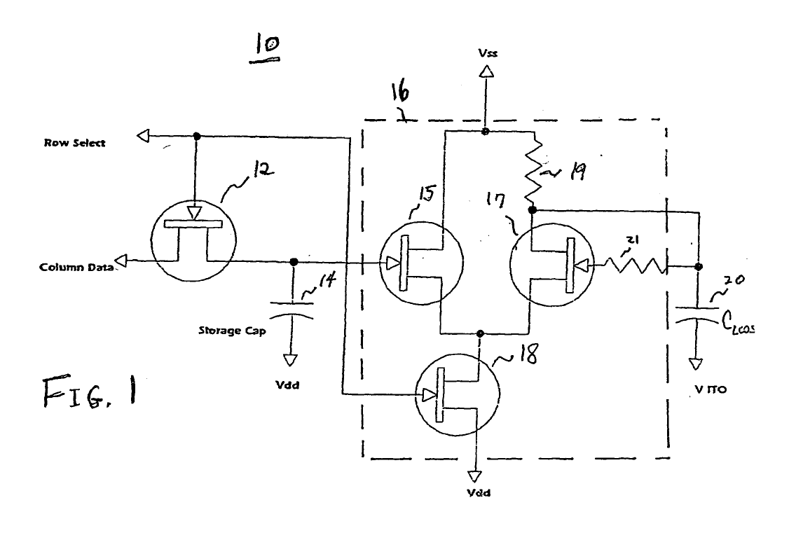

In order to overcome the problems described above, it is proposed to add an amplifier such as a differential amplifier 16 between the internal storage capacitance (14), and the LC cell (20) as shown in FIG. 1. In other words, a drive amplifier is added to the driving LC cell. This adds isolation between the storage capacitor and the LC cell. The added current drive capability ensures that the voltage on the pixel will rapidly become that desired. It also allows for very low leakage current from the storage capacitor (FET has very high input impedance), and allows for a continuous refresh of the voltage on the LC, which eliminates the ‘droop’ problem, as well as the residual voltaic potential stored in the cell. This should improve both the flicker issue, as well as the ‘image sticking’ problem which is associated with the inability to achieve DC balance in the cell. It should also allow the cell to work well even at somewhat elevated temperatures.

The disadvantage of this technique is that it increases the DC current through the liquid crystal cell. This disadvantage can be overcome in part by gating the current source in the bottom of the differential amplifier. This can use the ‘pixel select’ or ‘row select’ bit in the device (see FIG. 1). In this way, a periodic refresh of the voltage can be achieved, while reducing the power consumption by 1/nrow, where nrow is the number of rows in the device. Since heating is uniform, this gating in some situations may not be needed.

A typical implementation in CMOS is shown in FIG. 1. The components are schematic representations, and alternate configurations can be used without loss of generality. The key points are the amplifier 16, which applies a closed loop correction voltage to the LC cell, and the gated current source which allows reduction of power consumption.

Typically this circuit could be implemented with 3 transistors, which can be placed under the liquid crystal cell in an LCOS display device. In the arrangement of FIG. 1, the amplifier 16 decouples the LC cell from the memory element. FIG. 1 illustrates a liquid crystal cell driver 10 for a liquid crystal display. The liquid crystal cell driver preferably comprises a plurality of transistors (12, 15, 17, and 18) coupled to each other as shown in FIG. 1, a storage capacitance such as a storage capacitor 14, and a plurality of resistors 19 and 21. Preferably, three (3)transistors, such as transistors 15, 17 and 18 form the amplifier 16, preferably in the form of a differential amplifier which serves as the buffer or isolation amplifier. The differential amplifier 16 is preferably comprised of N-Channel transistors serving as an output to the liquid crystal cell. Additionally, the respective source electodes of the transistors of the differential amplifier are driven by a current source such as an N-Channel transistor such as transistor 18 that may be gated. This current mirror arrangement ensures a predetermined voltage on a given pixel. The differential amplifier 16 is coupled between the storage capacitor 14 and provides isolation between the storage capacitor 14 and a liquid crystal cell or pixel.

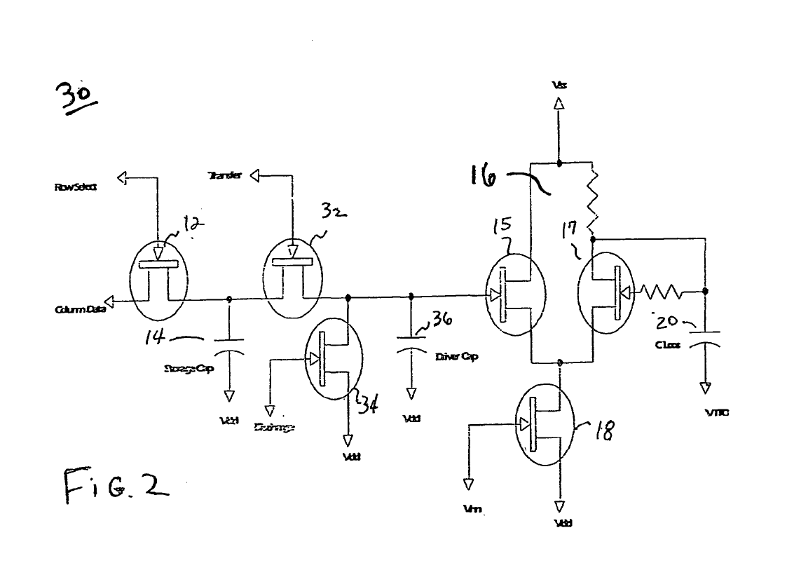

The arrangement of FIG. 2 adds a global switch element (32) to transfer data from the storage element to the driver. This allows for increased pixel drive for the same circuit operating voltages, and reduces image retention and flicker by allowing for inversion of the pixel drive voltage and the ITO transparent conductive electrode from frame to frame. Referring to FIG. 2, another liquid crystal cell driver 30 is shown similar to the liquid crystal cell driver 10 of FIG. 1. In addition to the elements previously recited with respect to cell driver 10, cell driver 30 further comprises a global switch element 32 in the form of a transistor coupled between the storage capacitor 14 and the differential amplifier 16. The global switch element transfers data from the memory cell to a driver capacitor 36 of the display driver.

The problem of flicker has been addressed by many mechanisms in the past. The issue of drive voltage and image retention has been addressed in digital drive LCOS displays. For analog systems, drive voltage and image retention issues can be addressed similarly, due to the need for continuous updating.

The main benefit of the technique disclosed herein is to separate the driver capacitor 36 from the storage capacitor 14. This separation as shown in FIG. 2 allows for updating all the cells of entire LC array at one time if desired. The benefit of this is two-fold. First, this separation (with further pre-processing to determine which LC cells have changed from frame to frame) also allows for updating of only the cells in the LC array that have changed from a prior frame. In other words, the contents of the storage capacitor 14 can be changed without instantaneously changing the display content on the LC cells. This greatly reduces the data rate needed for static pictures. It also allows for the possibility of driving the display in an interlaced mode without displaying interline scanning artifacts. In a system which is interlaced, normally odd lines are written on a first scan, and even lines are written on a second scan. This scanning scheme produces the artifact known as ‘interline flicker’. This even happens for data which is not intrinsically interlaced, such as film. The reason for “interline flicker” is that the even lines from one frame are displayed at the same time that the odd lines from the previous frame are displayed. Any portion of the frame which changed will show an interline flicker. With the present invention, a display having an array of storage capacitors (14) corresponding to an array of LC cells would be updated just as normal (even lines followed by odd lines), except that the entire LC array would then be updated once the storage array has been filled. Thus, lines from different fames are never displayed simultaneously. The second benefit of this technique is that it allows the common electrode voltage to be modulated from frame to frame. This modulation increases the effective electric field which can be applied to the LC cell for a given operating voltage of the driver circuit. This is a significant advantage, as finer process geometry will reduce the maximum allowed driving voltage. The benefits described above only occur when the pixels are all updated at once. The simultaneous updating of the pixels can only be done if the storage array (array of storage capacitors (14)) is separated from the driver array (array of driver capacitors (36)).

The technique can most simply be implemented with the circuit described in FIG. 1, with a modification as shown in FIG. 2. The voltage Vnn of FIG. 2 is a static voltage which controls the current source for the transistors 15 and 17. The Row and Column address are normal addressing for an active matrix display. The control signals (Transfer and Discharge) are separate globally controlled signals which transfer the charge on the storage capacitor 14 to the drive capacitor 36, which drives the LC cell. The additional transistors 32 and 34 and capacitor 36 on the device are added to implement the new circuit and operationally allows for the adequate discharge of current from the storage capacitor 14 after each transfer. The additional components should not be significant as process fabrication technology moves forward towards 0.1 microns and below.

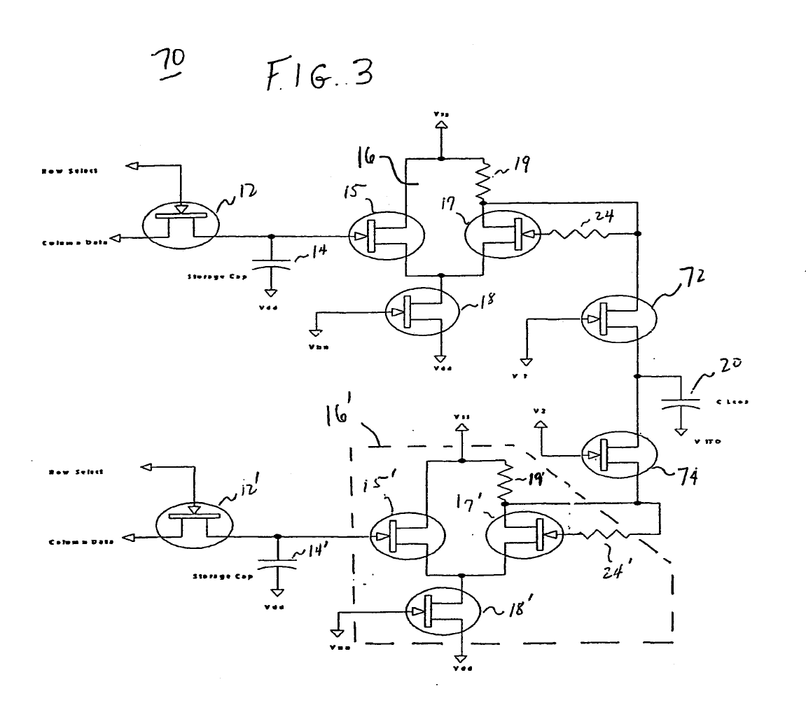

In the arrangement of FIG. 1, an isolation amplifier was added to decouple the LC cell from the memory element, as explained before. The additional embodiment of the invention of FIG. 3, adds a second cell driver portion having a second storage cell (preferably storage capacitor 14′) and amplifier (preferably differential amplifier 16′ including transistors 15′ and 17′ and 18′) and a pair of transistors (72 and 74) to switch between the two drive cells at a high rate of speed. The second drive cell also preferably comprises transistors 12′ and 18′ and resistors 19′ and 24′ arranged similarly to the embodiment of FIG. 1.) This eliminates flicker without the need for frame doubling. It can also be used to increase the drive voltage available on the cell.

The basic advantage of the embodiment of FIG. 3 for driving LCOS is that it uses two separate storage elements and drive circuits that are switched to drive the LC cell. This allows a fast switching frequency, which makes the flicker rate of the cell much above frequencies detectable by the human eye. It also allows for the possibility of switching the common electrode voltage (Vito) to help to increase the possible RMS voltage on the cell for a given operating voltage of the silicon back plane.

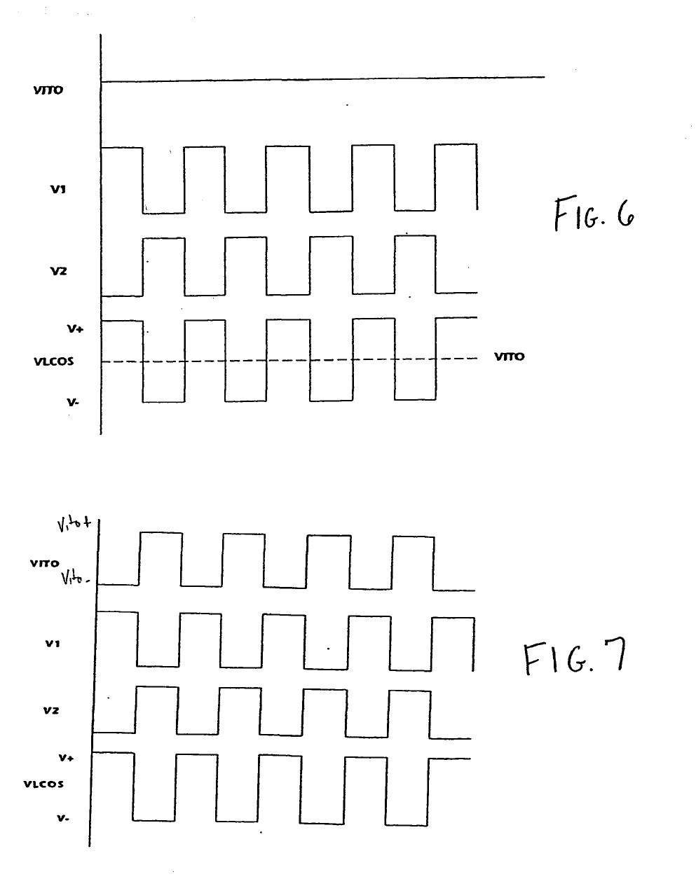

The upper cell (using transistor 72) contains the voltage to drive the LC during the ‘positive’ frame, the lower cell (using transistor 74) contains the voltage to drive the LC in the ‘negative’ frame. The voltage during the positive and negative frames must be balanced with Vito in order to avoid a net DC voltage on the cell, and resultant imager retention and reliability issues. VDD and VSS are the upper and lower operating voltages for the CMOS devices. VNN is set to regulate the current through the transistors of the differential amplifiers, and controls the power dissipation of the amplifier. V1 and V2 are global switching voltages which determine which amplifier is driving the Liquid Crystal cell. A timing diagram for a static Vito is shown in FIG. 6. A timing diagram for switched Vito is shown in FIG. 7.

Further referring to FIGS. 6 and 7, these timing diagrams reflect the ‘positive’ picture data (V+) in the upper storage cell (14) in FIG. 3, and the ‘negative’ picture data (V−) in the lower storage cell (14′). In the case of FIG. 6, Vito is not switched. When V1 is switched high (and V2 being low), the transistor 72 is turned on, and V+ is applied to the LC cell. The effective voltage on the cell is (V+−Vito). At the next switching time, V1 is switched low, and V2 is switched high. The transistor 74 is turned on, and V− is applied to the LC cell. The effective voltage on the cell is (Vito−V−).

In the case of FIG. 7, Vito is switched. When V1 is switched high (and V2 being low), the transistor 72 is turned on, and V+ is applied to the LC cell. Simultaneously, Vito is switched to low (Vito−), as shown in FIG. 7. The effective voltage across the LC cell is then (V+−Vito−). At the next switching time, V1 is set to low to turn off transistor 72, and switch V2 high to turn on transistor 74. This applies V− to the cell. Simultaneously, Vito is switched to high (Vito+), as shown in FIG. 7. The effective voltage across the LC cell is then (Vito+−V−).

If the maximum value of V+ and V− is fixed by the maximum voltage of the backplane process, then a fixed value of Vito as in FIG. 6 must be (V++V−)/2. If Vito can be switched, as in FIG. 7, Vito− can be V−, and Vito+ can be V+. Thus, the maximum effective voltage on the LC cell is (V+−V−)/2 for FIG. 6, but V+−V− for FIG. 7. The timing of FIG. 7 can ONLY be achieved on an analog system if all of the cells are updated simultaneously by the global switches V1 and V2.

Typically the time between V1 and V2 switching should be 1 or 2 msec. This will need to be determined for a given set of LC materials and the characteristics of the back plane, and response time of the devices.

The obvious detriment of this scheme is that it requires a large number of transistors to implement (perhaps as many as 12). This should be easily possible with a 20 micron pixel and a 0.35 micron process. Similar scaling on smaller pixels is possible with finer process geometry.

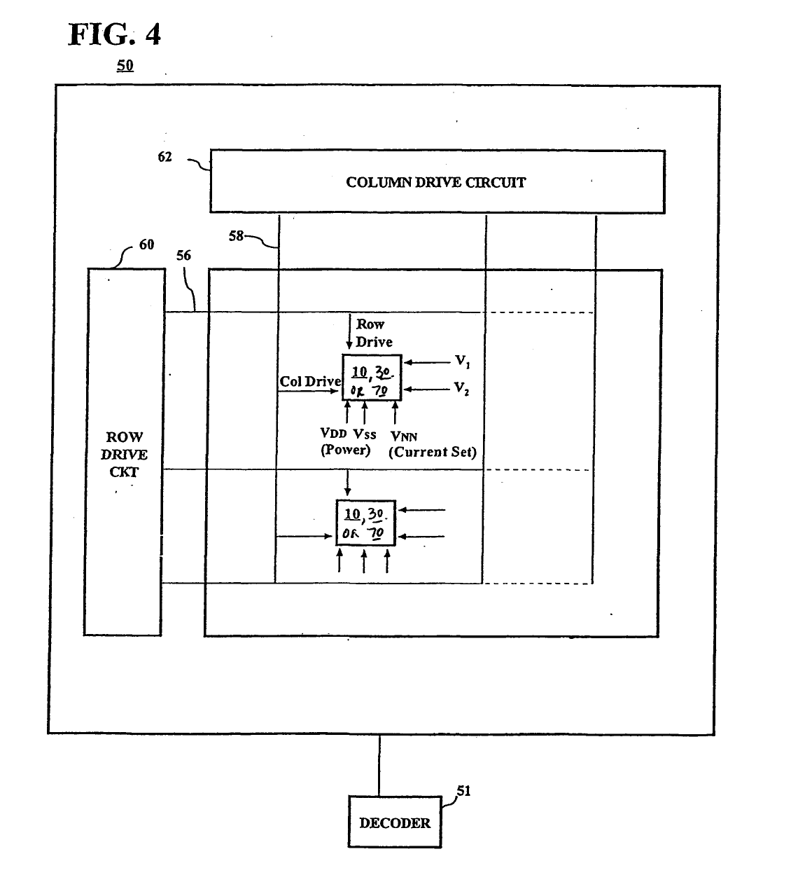

Now referring to FIG. 4, a display unit 50 is shown that can utilize the display drivers 20 or 30 or 70 as previously described above. The display unit 50 preferably includes a plurality of display elements arranged in a matrix of rows and columns and a memory element and a liquid crystal cell. The driver preferably switchably outputs one of a plurality of voltages to the display elements on at least one of the matrix of rows and columns, the display unit including a conventional decoder 51 and the driver controlled by the conventional decoder 51. The driver can include a storage capacitor and a differential amplifier coupled between the storage capacitor and the liquid crystal cell, whereby the differential amplifier provides isolation between the storage capacitor and the liquid crystal cell. The driver can include a decoder and a plurality of semiconductor switched controlled to be opened or closed by an output signal of the decoder 51. As shown in FIG. 4, the display unit 50 can include a row drive circuit having a plurality of row (scanning) address lines 56 and a column drive circuit 62 having a plurality of column (data) address lines 58.

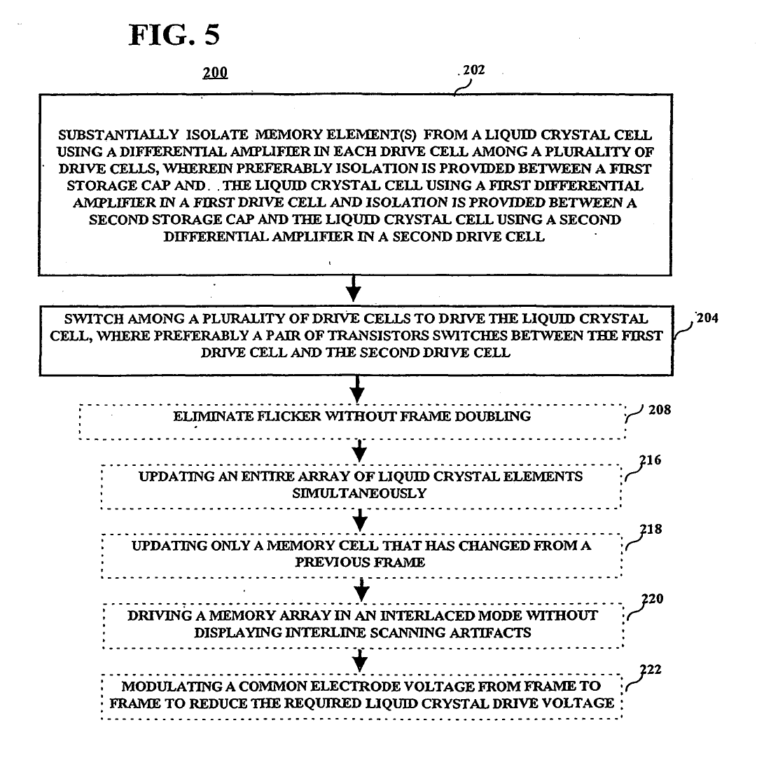

Referring to FIG. 5, a flow chart is shown illustrating a method 200 of driving a display in accordance with the present invention. The method 200 preferably comprises the step 202 of providing isolation between memory elements (such as a storage capacitor) and a liquid crystal cell using a differential amplifier in each drive cell among a plurality of drive cells. Preferably, the isolation is provided between a first storage capacitor and the liquid crystal cell using a first differential amplifier in a first cell and between a second storage capacitor and the liquid crystal cell using a second differential amplifier in a second cell. The method 200 also preferably comprises the step 204 of switching among the plurality of drive cells to drive the liquid crystal cell, where preferably a pair of transistors performs the function of switching between the first and second drive cells. Step 208 can further provide the step of eliminating flicker without frame doubling. The method 200 may further comprise the step 216 of updating an entire array of liquid crystal elements simultaneously and/or the step 218 of updating only a memory cell that has changed from a previous frame. Additional benefits of the method 200 may include the step 220 of driving a memory array in an interlaced mode without displaying interline scanning artifacts and/or the step 222 of modulating a common electrode voltage from frame to frame to reduce a required liquid crystal drive voltage.

Although the present invention has been described in conjunction with the embodiments disclosed herein, it should be understood that the foregoing description is intended to illustrate and not limit the scope of the invention as defined by the claims.

1. A display unit having an array of liquid crystal cells, comprising:
an array of display drivers, a given display driver being associated with a given liquid crystal cell and including:
a first storage capacitance and a first amplifier selectively coupled between the first storage capacitance and the given liquid crystal cell forming a first drive circuit;
a second storage capacitance and a second amplifier coupled between the second storage capacitance and the given liquid crystal cell forming a second drive circuit; and
a switching arrangement for switching the first and second drive circuits to the given liquid crystal cell.

2. The display driver of claim 1, wherein the first amplifier and the second amplifier are both differential amplifiers.

3. The display driver of claim 2, wherein the differential amplifier comprises a pair of N-Channel transistors having respective drain electrodes coupled and serving as an output to the liquid crystal cell.

4. The display driver of claim 1, wherein the each of said first and second drive circuits further comprises a global switch element coupled between the respective storage capacitance and the amplifier, wherein the global switch element transfers data from the storage capacitance to one of the first and second drive circuits.

5. The display driver of claim 1, wherein the switching mechanism comprises a first transistor driven by a first global switching voltage and a second transistor driven by a second global switching voltage.

6. A display driver for a given liquid crystal cell of an array of liquid crystal cells, comprising:
a first drive circuit coupled to a first memory element of the given liquid crystal cell;
at least a second drive circuit coupled to a second memory element of the given liquid crystal cell, wherein at least one of the first drive circuit and at least the second drives circuit includes an amplifier; and
a switching arrangement for repeatedly switching the liquid crystal cell between the first and at least the second drive circuits.

7. The display driver of claim 6, wherein each of the first and the second drive circuits comprise differential amplifiers comprising a pair of N-Channel transistors having respective source electrodes coupled to a current source and serving as an isolation amplifier to the liquid crystal cell.

8. The display driver of claim 6, wherein each of the first and the second drive circuits comprise differential amplifier comprising a pair of N-Channel transistors having respective sources coupled to a current source.

9. The display driver of claim 6, wherein the switching mechanism comprises a first transistor driven by a first global switching voltage and a second transistor driven by a second global switching voltage.

10. The display driver of claim 6, wherein the display driver further comprises a global switching element which is coupled between a storage capacitor and a differential amplifier and used for reducing image retention and flicker.

11. The display driver of claim 6, wherein the display driver updates an entire array of liquid crystal arrays elements simultaneously.

12. The display driver of claim 6, wherein the display driver updates only a memory cell that has changed from a previous frame.
